(19) United States
(12) Patent Application Publication
(10) Pub. No.: US 2015/0309590 A1
(43) Pub. Date: Oct. 29, 2015

(54) INPUTTING METHOD AND ASSOCIATED ELECTRONIC DEVICE

(71) Applicant: MediaTek Singapore Pte. Ltd., Singapore (SG)

(72) Inventors: Yang Wu, Chengdou City (CN); Wen-Kai Chiu, Taoyuan City (TW); Aifeng Nan, Xi'an City (CN)

(21) Appl. No.: 14/698,869

(22) Filed: Apr. 29, 2015

(30) Foreign Application Priority Data
Apr. 29, 2014 (CN) 201410176200.2

(51) Int. Cl. G06F 3/02; G06F 3/0489

(52) U.S. Cl. CPC G06F 3/0227; G06F 3/04897

(57) ABSTRACT

Inputting methods and associated electronic devices are provided. The method is applied to the electronic device to generate a key output. The electronic device includes an input method service framework and an input method application. The method includes: receiving a software keyboard layout from the input method application; receiving a user input; calculating a key value of the software keyboard layout corresponding to the user input; and determining the key output according to the key value.

### BACKGROUND

With the increasing popularity of smart phones, personal digital assistants (PDAs) and tablets, it is common to input texts by touching the screen of an electronic device or utilizing an external keyboard. The Android operating system is widely applied to smart phones and tablets. In the Android framework, the input method framework is divided into an input method service framework and an input method application, wherein the input method service framework is used to maintain switching of all input methods and manage input method information. The input method application has been developed by many designers for interactions between the user and the electronic device.

An electronic device, such as a smart phone, allows the user to manually download and install various input method applications, and interact with the electronic device. After the user touches the screen, a sensor would sense the input and notify the input method service framework. The input method service framework then notifies the input method application. The input method application would calculate key value of its software keyboard layout corresponding to the input and determine the key output. As well as commonly used words and phrases, the information that the user wishes to transmit via the input method application may also include private information, such as passwords, phone numbers, identification (ID) numbers and credit card numbers. Using the conventional structures, a designer of the input method application maybe able to intentionally collect a user's private information. In fact, some input method applications are specifically designed for collecting information inputted by users in order to study their habits and sometimes invade their privacy. Hence, some confidential or private information may be recorded or made public without user's authorization.

### SUMMARY

Inputting methods and electronic devices are provided to overcome the problems mentioned above.

In accordance with an aspect of the present invention, an inputting method is provided. The method is applied to an electronic device to generate a key output, wherein the electronic device includes an input method service framework and an input method application. The method includes: receiving a software keyboard layout from the input method application; receiving a user input; calculating a key value of the software keyboard layout corresponding to the user input by the input method service framework; and determining the key output according to the key value. In particular, the step of determining the key output according to the key value comprises determining whether the key output is output by the input method service framework according to the key value. When the key value is the specific key value, sending the key value to the input method application to be processed; and when the key value is the normal key value, outputting the key value as the key output.

In accordance with another aspect of the present invention, an electronic device is provided, which includes an input method application and an input method service framework. The input method service framework is arranged to receive a software keyboard layout from the input method application, receive a user input, calculate a key value of the software keyboard layout corresponding to the user input, and determine the key output according to the key value. In particular, the input method service framework determines whether the key output is output by the input method service framework according to the key value. When the key value is the specific key value, sending the key value to the input method application to be processed; and when the key value is the normal key value, outputting the key value as the key output.

Through utilizing the present invention, the protection of a user's private and confidential information may be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a flowchart illustrating an input method of the electronic device shown in FIG. 1 according to an embodiment of the present invention.

FIG. 3 is a diagram illustrating a software keyboard layout of the electronic device shown in FIG. 1 according to an embodiment of the present invention.

FIG. 4 is a diagram illustrating a software keyboard layout of the electronic device shown in FIG. 1 according to another embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

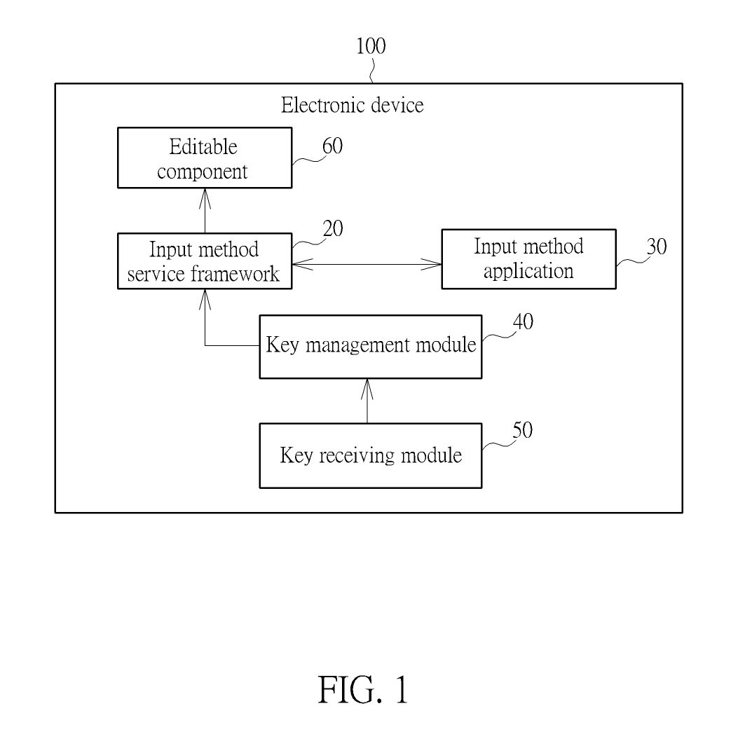

Please refer to FIG. 1, which is a diagram illustrating an electronic device 100 according to an embodiment of the present invention. The electronic device 100 maybe a smart phone or a tablet; this is merely for illustrative purposes, however, and not meant to be a limitation to the present invention. Any electronic devices which apply the method of generating key outputs as detailed herein fall within the scope of the present invention. The electronic device 100 includes an input method service framework 20, an input method application 30, a key management module 40, a key receiving module 50 and an editable component 60. Please note that, although the electronic device 100 in this embodiment includes the editable component 60, the editable component 60 may be external and coupled to the electronic device 100 in other embodiments. The key receiving module 50 may also be external and coupled to the electronic device 100 in other embodiments. The term “keys” in the present invention may refer to physical keys and/or virtual keys, and the keys may be arranged in various forms, e.g., the keys on a remote, or a joystick capable of generating key inputs. The key receiving module 50 may be a module arranged for receiving any of the aforementioned key inputs. Although FIG. 1 depicts components related to the present invention, the electronic device 100 may include other components. Moreover, the operations of the input method service framework 20, the input method application 30, the key management module 40 and the key receiving module 50 may be performed by a built-in processor of the electronic device 100 or an external processor coupled to the electronic device 100.

According to an embodiment of the present invention, the key receiving module 50 is used to receive key signals. The key management module 40 may be used to convert the key signals into user inputs. The user inputs may include a coordinate value (x, y) arranged for indicating locations of keys. For example, the key management module 40 may be a window management module, and the key receiving module 50 may be a touch screen arranged for receiving touch inputs from the user. The key management module 40 converts the touch inputs of the user into user inputs. The user inputs include the coordinate value (x, y) of the point touched by the user, to indicate the location of the touch. The input method service framework 20 is used to perform switching of all input methods and input method information management of the electronic device 100.

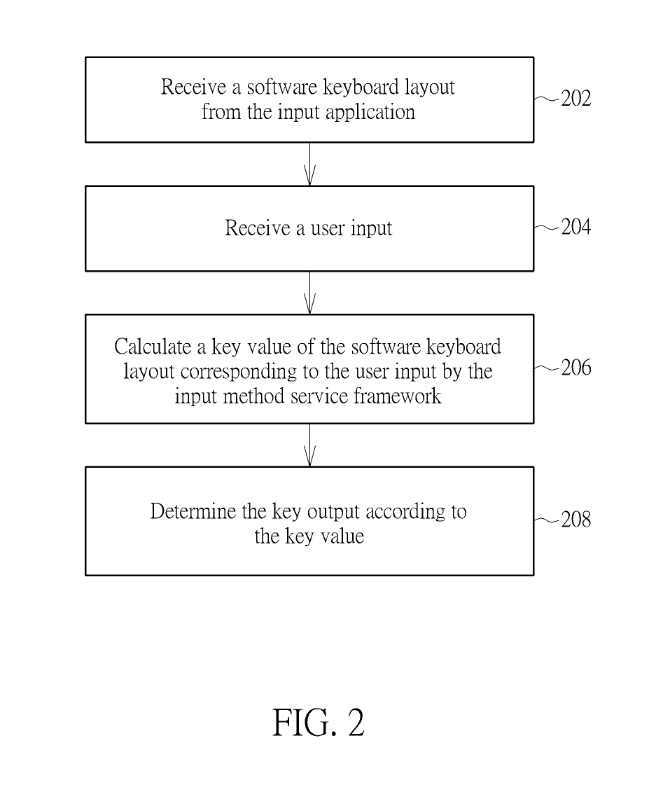

Please refer to FIG. 2, which is a flowchart illustrating an inputting method performed on the electronic device 100 shown in FIG. 1 according to an embodiment of the present invention. Provided that the result is substantially the same, the steps are not required to be executed in the exact order shown in FIG. 2. In an embodiment, the exemplary method can be briefly summarized using the following steps.

Step 202: Receive a software keyboard layout from the input method application.

Step 204: Receive a user input.

Step 206: Calculate a key value of the software keyboard layout corresponding to the user input by the input method service framework.

Step 208: Determine the key output according to the key value.

Please refer to FIGS. 1 and 2. In step 202, the input method service framework 20 receives the soft keyboard layout from the input method application 30. According to an exemplary embodiment of the present invention, step 202 may be implemented as follows: In the beginning, the input method service framework 20 informs the input method application 30 to prepare the soft keyboard. For example, the input method service framework 20 may send an editable window range and a first request to the input method application 30. In an embodiment, the editable window range may be information related to screen window region that can be occupied, and the first request may request the input method application 30 to perform a corresponding keyboard layout for the software keyboard in the editable window range. When the software keyboard is ready, the input method application 30 may send keyboard readiness information to the input method service framework 20. When the input method service framework 20 receives the keyboard readiness information, the input method service framework 20 may send a second request to the input method application 30, to request the input method application 30 to report the software keyboard layout.

The input method service framework 20 may receive the user inputs in step 204, and calculate the key value of the software keyboard layout corresponding to the user inputs in step 206. The step of receiving the user inputs includes receiving the user inputs form the key management module 40. The step of receiving the user inputs from the key management module 40 includes receiving key inputs from the key receiving module 50, utilizing the key management module 40 to convert the key inputs into user inputs, and receiving the user inputs from the key management module 40. For example, when the user touches the touch screen, the key management module 40 may obtain the user inputs according to the generated touch input information (e.g. the coordinate (x, y) of the user touched point). For example, the key management module 40 may receive the touched key position, the touch duration and the touch strength of the touch on the electronic device 100. However, the aforementioned examples are merely for illustrative purposes, and not meant to be limitations to the present invention. In another example, the electronic device 100 may be a portable device or a personal computer. The user may further perform key inputs on the electronic device 100 through a physical (hardware) keyboard to generate the user inputs. In some embodiments of the present invention, the order of performing steps 202 and 204 may be reversed. Further, in some embodiments of the present invention, steps 202 and 204 may be performed simultaneously.

In step 208, the input method service framework 20 determines the key outputs according to the key values. Specifically, the input method service framework 20 may determine whether the generated key value is a normal key value or a specific key value. If the key value is a specific key value, the input method service framework 20 may send this specific key value to the input method application 30 to be processed instead of directly outputting this specific key value as the key output. If the key value is a normal key value, the input method service framework 20 may directly output this normal key value as the key output. In an embodiment, if the key value is a normal key value, the input method service framework 20 may send this normal key value to the editable component 60. In an example, the input method application 30 may further update the software keyboard layout after processing some specific key values, and send the updated software keyboard layout to the input method service framework 20 immediately, periodically, or after receiving a request from the input method service framework 20.

For example, the key values corresponding to letters A-Z of the English alphabet, Arabic numerals 0-9, and symbols @, # and $ may be classified as normal key values. Further, some key values arranged to switch input method languages or pop up a facial expression list may be classified as specific key values. Please note that this is merely for illustrative purposes. Different input method applications may correspond to different specific key values. In an embodiment of the present invention, only the key values asserted as specific key values by the input method application 30 are specific key values, and the remaining key values are normal key values. When the input method service framework 20 determines generated key values as specific key values, this means that the current user input is not used as a direct output for the keyboard (e.g. the output for the editable component 60). The input method service framework 20 sends this specific key value to the input method application 30 to be processed. The input method service framework 20 may send the specific key value corresponding to an input method language switching to the input method application 30, and the input method application 30 may switch the current input method language according to this specific key value.

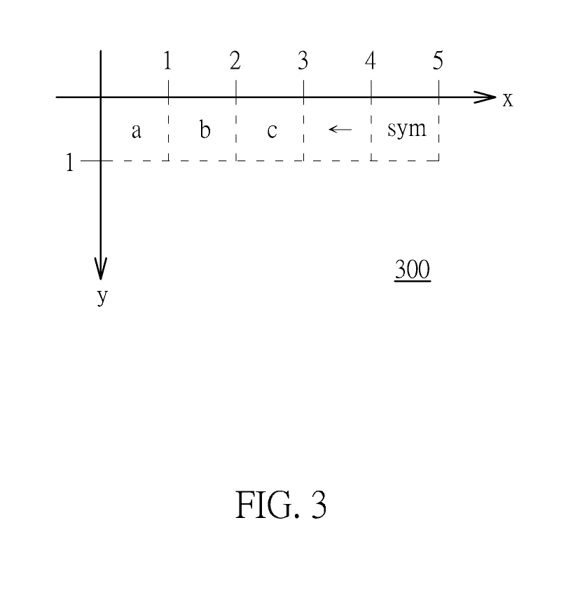

Please refer to FIG. 3, which is a diagram illustrating a software keyboard layout 300 of the electronic device 100 shown in FIG. 1 according to an embodiment of the present invention. The software keyboard layout 300 may be displayed on the touch screen. The x-axis, y-axis and the coordinates may not need to be shown to the user. The touch blocks “a, b, c, ←, sym” are sequential from left to right in FIG. 3. “←” is the backspace key and “sym” is the key for switching input method languages. The “SecureKeyboardInfo” of the above touch blocks are shown in Table (1). The SecureKeyboardInfo is a category newly added in the input method 30, which includes key value positions, key values and corresponding marks. The input method application 30 packs this category, and sends it back to the input method service framework 20 (step 202). Then, the input method service framework 20 saves this category and processes the touch screen information of the user through querying this category (step 206).

TABLE (1)

| | Touch block | | | | |
|---|---|---|---|---|---|
| | A | b | c | ← | sym |
| Key value position | (1, 1, 1, 1) | (2, 1, 1, 1) | (3, 1, 1, 1) | (4, 1, 1, 1) | (5, 1, 1, 1) |
| Key value | A | b | c | back_space | −101 |
| Mark | Normal | Normal | Normal | Normal | IME_HANDLE |

The aforementioned newly added category is not meant in a limiting sense. Each existing input method application may perform its own software keyboard layout, and report its software keyboard layout to the input method service framework 20.

Suppose the key value position corresponding to the touch block “a” is (1,1,1,1).The first and second “1” (from left to right) represent the coordinate (x, y) of the touch block “a”, respectively, and the third and fourth “1” (from left to right) represent the length and the width of the touch block “a”, respectively. When the touch block “c” is touched, the key management module 40 reports the key value position (3,1,1,1) to the input method service framework 20. Then, the input method service framework 20 determines the key value corresponding to the key value position (3,1,1,1) is “c” (step 206), and determines the mark corresponding to the key value “c” is “Normal” (i.e. a normal key). In this way, the key value “c” will be directly outputted.

Further, when the touch block “sym” is touched, the key management module 40 informs the input method service framework 20 that the key value position is (5,1,1,1). Then, the input method service framework 20 determines the key value corresponding to the key value position (5,1,1,1) is “−101”, and determines the mark corresponding to the key value “−101” is “IME_HANDLE” (i.e. a specific key). In this way, the key value “−101” will not be directly outputted, but will be sent to the input method application 30 instead, so that the input method application 30 will switch the currently used software keyboard layout. Please note that, this is merely for illustrative purposes; the specific key values may be used to perform the following operations, for example: switching a virtual keyboard, switching the input way (e.g. switch to voice input), and entering the input method application settings.

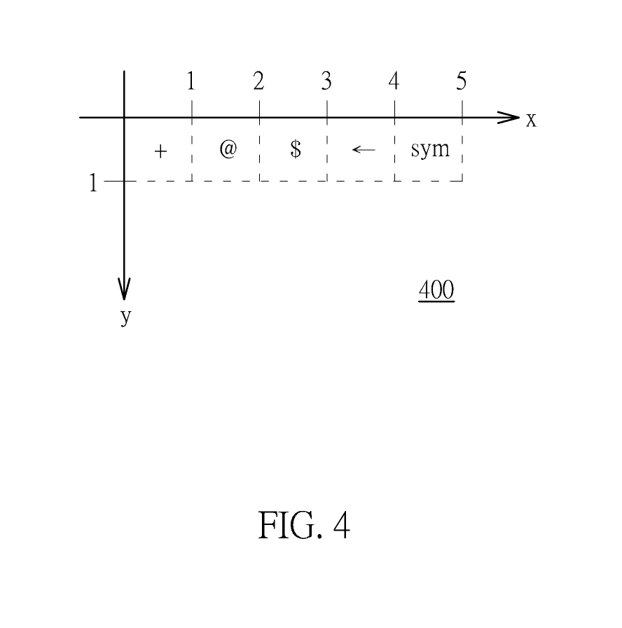

Please refer to FIG. 4, which is a diagram illustrating a software keyboard layout 400 of the electronic device 100 shown in FIG. 1 according to another embodiment of the present invention. When the touch block “sym” of the software keyboard layout 300 is touched, the input method service framework 20 may replace the software keyboard layout 300 with the software keyboard layout 400 shown in FIG. 4, and display the software keyboard layout 400 on the touch screen. The x-axis, y-axis and the coordinate may not need to be shown to the user. Please note that the aforementioned software keyboard layouts 300 and 400 are illustrated as examples, and not meant to be limitations of the present invention.

As mentioned above, through utilizing the electronic device and input method provided by the embodiments of the present invention, the step of calculating key values corresponding to the user inputs on the software keyboard layout (step 206) is performed in the input method service framework 20 instead of being performed in the input method application 30. More specifically, the key values are calculated by the input method service framework 20 in advance without being accessed by the input method application 30. The input method application 30 therefore cannot know the information that the user inputs, and consequently, a third party/the developer are unable to invade the user's privacy, so that the user's confidential information will be well protected.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An inputting method, applied to an electronic device to generate a key output, wherein the electronic device comprises an input method service framework and an input method application, the method comprising:
receiving a software keyboard layout from the input method application;
receiving a user input;
calculating a key value of the software keyboard layout corresponding to the user input by the input method service framework; and
determining the key output according to the key value.

2. The method of claim 1, further comprising:
sending an editable window range and a first request to the input method application, wherein the first request requests the input method application to perform keyboard layout within the editable window range; and
sending a second request to the input method application, to request the input method application to report the software keyboard layout.

3. The method of claim 1, wherein the user input is generated by a user touching at least a key of the electronic device.

4. The method of claim 1, wherein the step of determining the key output according to the key value comprises:
determining whether the key output is output by the input method service framework according to the key value.

5. The method of claim 4, wherein the step of determining the key output according to the key value comprises:
determining whether the key value is a normal key value or a specific key value by the input method service framework;
when the key value is the specific key value, sending the key value to the input method application to be processed; and
when the key value is the normal key value, outputting the key value as the key output by the input method service framework.

6. The method of claim 5, wherein the input method application updates the software keyboard layout after processing the key value.

7. The method of claim 6, further comprising:
receiving an updated software keyboard layout immediately, periodically, or after sending a request.

8. An electronic device, comprising:
an input method application; and
an input method service framework, for receiving a software keyboard layout from the input method application, receiving a user input, calculating a key value of the software keyboard layout corresponding to the user input, and determining the key output according to the key value.

9. The electronic device of claim 8, wherein the input method service framework is used to send an editable window range and a first request to the input method application, wherein the first request requests the input method application to perform keyboard layout within the editable window range; and the input method service framework is used to send a second request to the input method application to request the input method application to report the software keyboard layout.

10. The electronic device of claim 8, further comprising:
a key management module, for receiving a key input, converting the key input into the user input, and sending the user input to the input method service framework.

11. The electronic device of claim 8, wherein the input method service framework determines whether the key output is output by the input method service framework according to the key value.

12. The electronic device of claim 11, wherein the input method service framework determines whether the key value is a normal key value or a specific key value; when the key value is the specific key value, the input method service framework sends the key value to the input method application to be processed; and when the key value is the normal key value, the input method service framework outputs the key value as the key output.

13. The electronic device of claim 12, wherein the input method application updates the software keyboard layout after processing the key value.

14. The electronic device of claim 13, wherein the input method service framework receives an updated software keyboard layout from the input method application immediately, periodically, or after sending a request.
